(19) United States
(12) Patent Application Publication
(10) Pub. No.: US 2011/0178938 A1
(43) Pub. Date: Jul. 21, 2011

(54) SYSTEM AND METHOD FOR ASSESSING ENVIRONMENTAL FOOTPRINT

(75) Inventors: Corinne REICH-WEISER, Menlo Park, CA (US); Bryant C. BROOKS, San Rafael, CA (US); Chris ERICKSON, Berkeley, CA (US); Tristan FLETCHER, Pleasant Hill, CA (US); Yvonne M. BURGESS, Berkeley, CA (US)

(73) Assignee: Climate Earth, Inc., San Francisco, CA (US)

(21) Appl. No.: 13/073,961

(22) Filed: Mar. 28, 2011

(51) Int. Cl. G06Q 99/00

(52) U.S. Cl. 705/317

(57) ABSTRACT

An environmental footprint assessment system is disclosed. The environmental footprint assessment system determines the environment footprint of an entity by analyzing financial information regarding the entity. For example, the environmental footprint assessment system may determine the carbon footprint of a business. The environmental footprint assessment system compares an entity's financial information against a database of environmental impacts to produce an initial carbon footprint assessment for the entity. The initial assessment is reviewed for areas of spending that contribute significant to the entity's carbon footprint. The database of environmental impacts can be refined with additional environmental impact information regarding the areas of significant carbon contribution. A subsequent iteration of the carbon footprint assessment is performed, and an updated carbon footprint assessment is produced. The process is repeatedly iteratively to produce additional carbon footprint assessments.

### BACKGROUND

1. Field

The present application generally relates to an environmental footprint assessment system. More particularly, the present application relates to a system for assessing the carbon footprint of a business entity, using financial information of the business entity.

2. Related Art

An environmental footprint is the total of environmental exchanges between an entity and the environment. An environmental exchange may be an emission or consumption of a material, service, and/or energy. A popular measure of environmental footprint is the total of greenhouse gas (GHG) emissions by an entity, also referred to as a carbon footprint. As the public has become increasingly aware of the harmful effects of GHG emissions, entities, such as businesses, are incentivized to reduce their carbon footprint for the sake of environmental responsibility, and for their business goodwill. A carbon footprint must be accurately measured, however, before it can be reduced meaningfully.

Traditionally, the individual GHG-producing activities of a business are identified and aggregated in order to determine the business's carbon footprint. Since a business contributes to GHG emissions directly and indirectly, a large number of GHG-producing activities must be identified during a carbon footprint assessment. The identification of direct and indirect GHG emissions can be difficult. For instance, indirect emissions, such as those attributable to a business's purchases from upstream suppliers, are usually too numerous to identify completely. Similarly, the collection of direct emissions data from suppliers is often difficult. Suppliers often do not cooperate, and the data collection process itself is costly and time-consuming.

Even when information regarding a business's activities are identifiable, the information may be spread across disparate systems of record. For instance, a business may record its consumption of materials, services, and energy across multiple systems. Some activities may not be individually tracked or recorded at all. The time and cost involved in making each record available often render a traditional carbon footprint assessment infeasible.

To overcome the issues of numerosity and unavailability, a traditional carbon footprint assessor focuses on GHG-emitting activities that are perceived as most “significant” to the business's carbon footprint, and omits GHG-emitting activities that are perceived as “insignificant.” However, the problem lies in that no general rule can be established to determine the significance or insignificance of an activity without first collecting GHG emissions data for all activities. The traditional carbon footprint assessment is thus inherently incomplete.

### SUMMARY

In an exemplary embodiment, a system for assessing and displaying an environmental footprint of an entity by analyzing financial data regarding the entity is implemented by a computer. The computer comprises a processor and memory. The system accesses the financial data of the entity, which represents the entity's spending on a plurality of financial items. A first environmental impact database, which includes a matrix of appropriations between each spend item of a plurality of spend items, and the other spend items of the plurality of spend items, which represents a consumption or an emission of one or more of the plurality of spend items, due to producing or consuming of a spend item of the plurality of spend items is also accessed. The system receives a determination of one or more relationships between one or more of the financial items of the financial data, and one or more of the spend items of the first environmental impact database. A second environmental impact database, which includes a plurality of environmental impacts, wherein each of the plurality of spend items is correlated to one or more of the plurality of environmental impacts, and wherein each of the plurality of environmental impacts represents an emission or a removal of a resource of a plurality of resources is also accessed. The system calculates a first environmental footprint estimate, based on the one or more relationships, the first environmental impact database, and the second environmental impact database, wherein the first environmental footprint estimate includes the emission or the removal of the plurality of resources related to the plurality of financial items of the entity. A new spend item may be added to the first environmental database, and the first environmental database may be updated to include the appropriation between the new spend item, and the other spend items of the plurality of spend items. The system calculates a second environmental footprint estimate corresponding to the plurality of financial items of the financial data, based on the one or more relationships, the updated first environmental impact database, and the second environmental impact database, wherein the second environmental footprint estimate includes the emission or the removal of the plurality of resources related to the plurality of financial items of the entity, and causes a display of the second environmental footprint estimate in relation to the financial items of the entity.

In one embodiment, the system receives an identification of a target spend item from the plurality of spend items of the first environmental impact database based on the first environmental impact estimates, and updates, in the first environmental impact database, the appropriation between the target spend item, and the other spend items of the plurality of spend items. The system then calculates a third environmental footprint estimate corresponding to the plurality of financial items of the financial data, based on the relationship, the updated first environmental impact database, and the second environmental impact database.

In one embodiment, the system further adds, to the second environmental database, an environmental impact that is correlated to the new spend item; and calculates a third environmental footprint estimate corresponding to the plurality of financial items of the financial data, based on the relationship, the updated first environmental impact database, and the updated second environmental impact database.

In another exemplary embodiment, a system for assessing and displaying an environmental footprint of an entity by analyzing financial data regarding the entity comprises accessing the financial data of the entity. The financial data may represent the entity's spending on a plurality of financial items. The system accesses a first environmental impact database, wherein the first environmental impact database includes a matrix of appropriations between each of a plurality of spend items, and the other spend items of the plurality of spend items, wherein each appropriation represents a consumption or an emission of one or more of the plurality of spend items, due to producing or consuming of a spend item of the plurality of spend items. The system receives a determination of one or more relationships between one or more of the financial items of the financial data, and one or more of the spend items of the first environmental impact database, and accesses a second environmental impact database, wherein the second environmental impact database includes a plurality of environmental impacts, wherein each of the plurality of spend items is correlated to one or more the plurality of environmental impacts, and wherein each of the plurality of environmental impacts represents an emission or a removal of a resource of a plurality of resources. The system then calculates a first environmental footprint estimate, based on the one or more relationships, the first environmental impact database, and the second environmental impact database; wherein the first environmental footprint estimate includes the emission or the removal of the plurality of resources related to the plurality of financial items of the entity. The system receives an identification of a target spend item from the plurality of spend items of the first environmental impacts database, accesses a third environmental impact database, wherein the third environmental impact database includes an appropriation between the target spend item and the plurality of spend items, wherein the appropriation represents a consumption or emission of one or more of the plurality of spend items, due to producing or consuming of the target spend item, and accesses a fourth environmental impact database, wherein the fourth environmental impact database includes a plurality of environmental impacts that are correlated to the plurality of spend items, and wherein each of the plurality of environmental impacts represents the emission or the removal of a resource of the plurality of resources. The system calculates a second environmental footprint estimate corresponding to the plurality of financial items of the financial data, based on the one or more relationships, the third environmental impact database, and the fourth environmental impact database, wherein the second environmental footprint estimate includes the emission or the removal of the plurality of resources related to the plurality of financial items of the entity, and causes a display of the second environmental footprint estimate in relation to the financial items of the entity.

In another exemplary embodiment, instructions for carrying out the technology described above may be stored into a non-transitory computer-readable storage medium. In yet another exemplary embodiment, instructions for carrying out the technology described above may be implemented in a computer that includes a memory for storing the instructions and a processor for carrying out the instructions. In yet another exemplary embodiment, instructions for carrying out the technology described above may reside in cloud storage, or may reside with a cloud service provider.

### BRIEF DESCRIPTION OF THE DRAWINGS

FIG. 1 depicts a block diagram of an exemplary embodiment of an environmental footprint assessment system.

FIG. 2 depicts a flow chart of an exemplary environmental footprint assessment.

FIG. 3 depicts a block diagram of an exemplary process for mapping financial information to commodities and services.

FIG. 4 depicts a block diagram of another process for mapping financial information to commodities and services.

FIG. 5 depicts a matrix representing an exemplary component of an environmental impacts database.

FIG. 6 depicts a matrix representing another component of an environmental impacts database.

FIG. 7 depicts a mathematical equation for assessing an environmental footprint.

FIG. 8 depicts an exemplary interface for viewing an environmental footprint estimate.

FIG. 9 depicts an exemplary interface for viewing an environmental footprint estimate.

FIG. 10 depicts a matrix representing an expanded environmental impacts database.

FIG. 11 depicts a matrix representing an expanded environmental impacts database.

FIG. 12 depicts a matrix representing a hybridized environmental impacts database.

FIG. 13 depicts a block diagram of an exemplary process for re-mapping financial data to commodities and services.

### DETAILED DESCRIPTION

The embodiments described herein include an environmental footprint assessment system (EFAS) for assessing the environmental footprint of an entity based on the entity's financial information. The EFAS is a component of an environmental business intelligence system. An environmental business intelligence system may allow an entity to systematize management of all internal operations and its supply chain, and is used to facilitate green procurement, external reporting, product assessment, and compliance with governmental mandates.

As used here, financial information includes, but is not limited to, documents such as general ledgers, bills of materials, profit and loss statements, trial balances, purchase orders, supplier invoices, and so forth. An entity is any type of organization or subset thereof, such as a business, a non-profit group, a government office, a department, a business unit, and so forth. An entity may also be a person or a group of persons.

In one embodiment, the EFAS is adapted to assess the GHG emissions, also referred to as a carbon footprint, of a business entity. It should be noted, however, that the methods and techniques described herein could be applied to assess the exchange of other emissions, materials, and energy with the environment by other kinds of entities. For example, in another embodiment, the EFAS is adapted to assess the release of toxins into freshwater by the members of a private organization.

The World Resources Institute (WRI) has defined three categories of GHG emissions. Scope 1 emissions are those due to entity-owned activities. Scope 2 emissions are those due to an entity's direct consumption of electricity and steam. Scope 3 emissions are all other emissions attributable to an entity. Scope 3 is further divided into upstream emissions and downstream emissions. Upstream scope 3 emissions are those due to an entity's supply chain. Downstream scope 3 emissions are those due to the use and obsolescence of an entity's products.

In one embodiment, the EFAS is adapted to assess the scope 1, scope 2, and upstream scope 3 GHG emissions of a business entity. It should be noted, however, that the EFAS may be adapted to assess other combinations of scope 1, scope 2, and scope 3 emissions. For instance, in another embodiment, the EFAS is adapted to assess scope 1, scope 2, and scope 3 (both upstream and downstream) emissions.

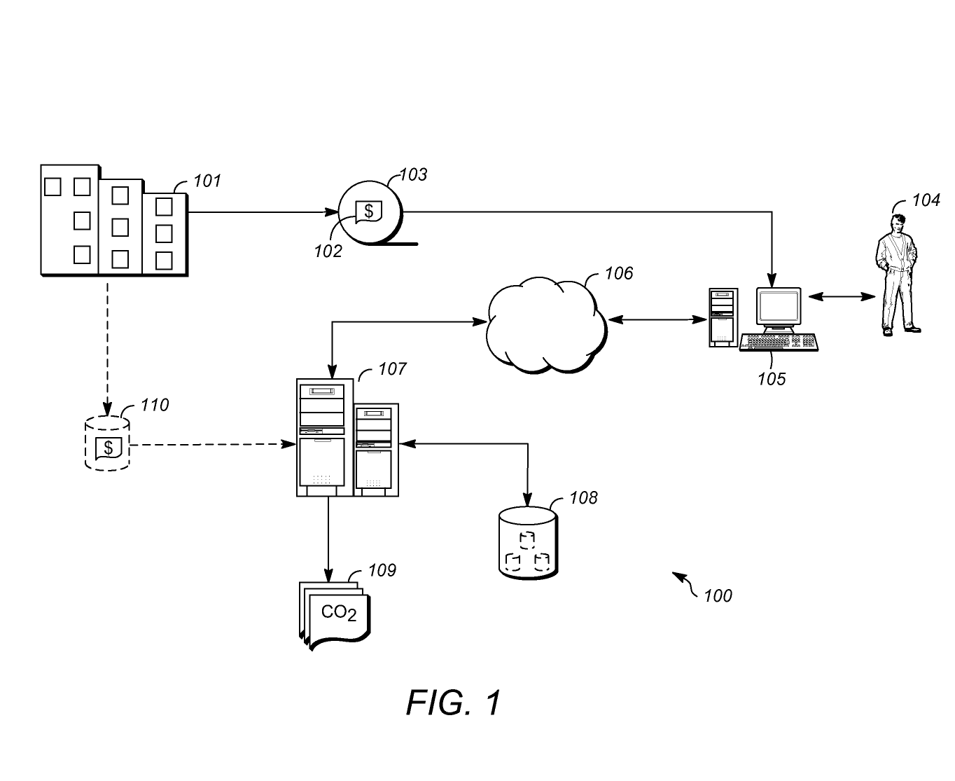

FIG. 1 illustrates the components related to an exemplary embodiment of EFAS 100. Business entity 101 is an entity that produces financial information 102 during the course of its operations. Financial information 102 is maintained in data files 103. Computer workstation 105 receives instructions from user 104 to upload data files 103 (containing financial information 102), through network 106, to server 107. Once data files 103 are uploaded, financial information 102 contained therein become accessible to server 107. Server 107 analyzes financial information 102 against environmental impacts database 108 and produces carbon footprint estimate 109. Server 107 is also adapted to cause the display of carbon footprint estimate 109 on computer workstation 105, so that carbon footprint estimate 109 may be reviewed by user 104.

In the present embodiment, computer workstation 105 and server 107 communicate via network 106, which is an Intranet of business entity 101. The uploading of data files 103 is initiated using a web user interface running on computer workstation 105. In other embodiments, EFAS 100 is adapted for use over the Internet, on a virtual private network of business entity 101, and/or on a hybrid network that includes private and public network portions. In yet another embodiment, financial information 102 resides on a storage unit 110 that is accessible to server 107. Storage unit 110 may be a component of another system, such as a financial application or an enterprise resource planning application.

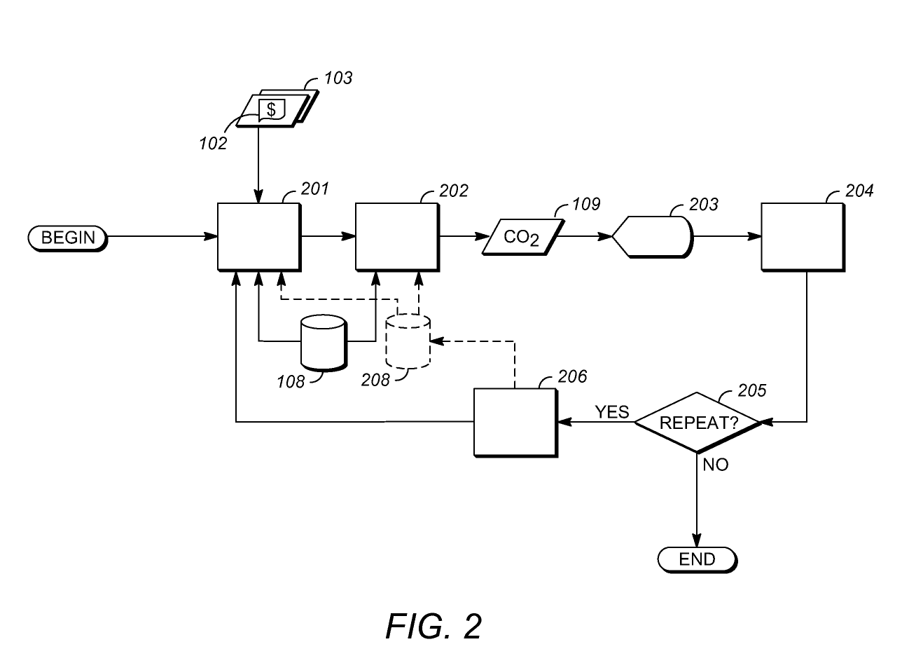

With continued reference to FIG. 1, and turning simultaneously to FIG. 2, the processes in an exemplary carbon footprint assessment performed using the present embodiment of EFAS 100 (FIG. 1) are discussed. In process 201, EFAS 100 (FIG. 1) accesses data files 103 (FIG. 1) containing financial information 102 (FIG. 1) as input, and maps financial information 102 (FIG. 1) to a list of commodities and services known to EFAS 100. In process 202, the mappings created in process 201 are evaluated against environmental impacts database 108 (FIG. 1), and an initial carbon footprint estimate 109 (FIG. 1) for business entity 101 (FIG. 1) is produced. In process 203, carbon footprint estimate 109 (FIG. 1) is displayed to a user. In process 204, the user identifies one or more areas of spending that contribute significantly to carbon footprint estimate 109 (FIG. 1). In decision 205, the user decides whether to further focus on the areas of spending that are identified as significant carbon footprint contributors during process 204, in order to refine carbon footprint estimate 109.

Decision 205 is based, in part, on whether additional information regarding the areas of spending identified in process 204 can be obtained. If additional information is not obtainable, the present carbon footprint assessment is complete, and carbon footprint estimate 109 (FIG. 1) is the final carbon footprint assessment for business entity 101 (FIG. 1). If additional information is obtainable, it is obtained in process 206. An updated environmental impacts database 208 is produced based on the additionally obtained information in process 206.

At the completion of process 206, a next iteration of the carbon footprint assessment begins at process 201 again. During the next iteration of the carbon footprint assessment, environmental impacts databases 108 and 208, either alone or in combination, are accessible to EFAS 100 (FIG. 1). A complete carbon footprint assessment may span multiple iterations, and further refinements may be made to updated environmental impacts database 208 during each iteration.

### 1. Accessing Financial Information

Process 201 is now discussed in additional detail with reference to FIG. 1. Specifically, process 201 includes: First, the accessing of financial information 102, and second, the mapping of financial information 102 to categories of commodities and services that are known to EFAS 100.

Financial information 102 includes information related to spending by business entity 101 on various commodities and services, and is made accessible to EFAS 100 by way of the upload process discussed above. EFAS 100 uses financial information to assess carbon footprints because financial information is maintained routinely, and is usually kept accessible by a typical business. In addition, financial information provides an accurate and holistic view of a business's activities, because financial information is generally audited for compliance with established standards, such as the Generally Accepted Accounting Principles (GAAP).

Furthermore, the use of financial information 102 in process 201 by EFAS 100 obviates the need to organize a special set of input data for the purpose of a carbon footprint assessment. Any area of spending that is sufficiently important to be maintained on the financial books of business entity 101 can be accounted for by EFAS 100 through the use of financial information 102. Moreover, audit and GAAP safeguards help ensure that financial information 102 provides insight even into obscure areas of spending, such as spending on consumables, amortized properties, office supplies, and so forth. These areas of spending may contribute significantly to a business's carbon footprint in the aggregate, but are difficult to track individually. Their inclusion in financial information 102 allows EFAS 100 to properly account for their carbon footprint contributions. Their inclusion in financial information 102 may also allow EFAS 100 to completely account for their carbon footprint contributions.

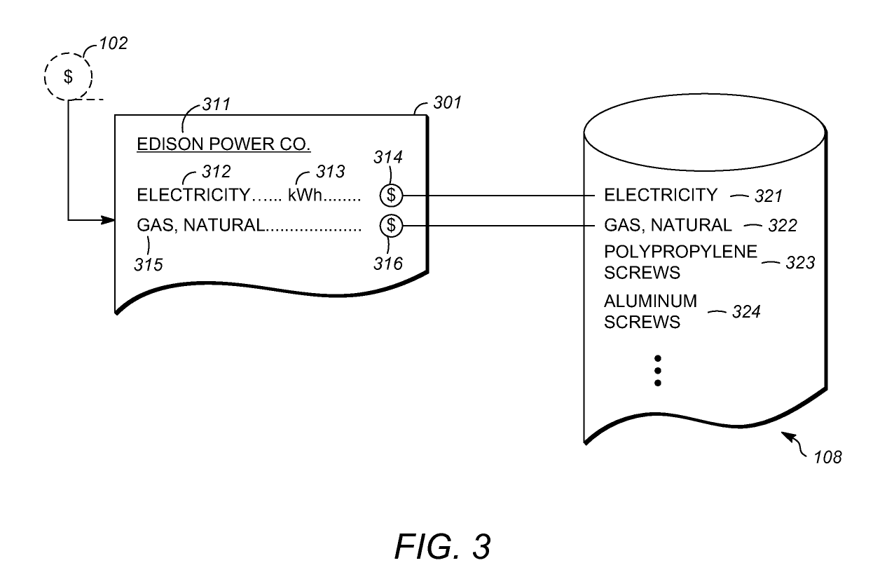

Once financial information 102 is made accessible to EFAS 100 through the upload process, it is mapped to categories of commodities and services that are known to EFAS 100. In FIG. 3, financial document 301 is a utility invoice included within financial information 102 (FIG. 1). Financial line item 312 of financial document 301 indicates electricity usage, and is mapped to electricity service category 321. Similarly, financial line item 315, which indicates gas usage, is mapped to natural gas commodity category 322.

Sometimes, a financial document may indicate the consumption of a commodity (or service) using multiple units-of-measure (UOM). The multiple UOMs may correspond to, for example, a physical usage and a financial usage of the commodity. For example, financial line item 312 of utility invoice 301 indicates electricity usage in terms of physical usage 313 and financial usage 314. Physical usage 313 is provided in the UOM of kilowatt-hours (kWh), and financial usage 314 is provided in the UOM of U.S. dollars (USD). In contrast, financial line item 315, which indicates gas usage, includes only financial usage 316 in USD.

During the mapping of a financial line item in process 201 (FIG. 2), the financial usage indicated on the financial line item is always recorded, and the physical usage indicated on the financial line item is optionally recorded. For example, during the mapping of financial line item 312 to electricity service category 321, financial usage 314 is always recorded, and physical usage 313 is optionally recorded.

The optional recordation of physical usage information during the mapping process obviates the need to translate a financial usage into a physical usage later on during the carbon footprint assessment. Moreover, physical usage information is less likely to be affected by external factors that can complicate the calculation of a physical usage from a financial usage. For example, a supplier's tier-pricing scheme affects the marginal price of its commodities (or services). Thus, in a municipality where tier-pricing is in effect, the average cost of a commodity depends on an entity's total consumption of the commodity. In such a municipality, the translation of a financial usage into a physical usage is complicated because the average cost of the commodity is inconsistent. Translation can be avoided altogether if physical usage information is optionally recorded during the mapping process.

The recordation of financial usage information during the mapping process is useful because the recordation of financial usage information allows EFAS 100 (FIG. 1) to later report a carbon footprint estimate in the context of financial statistics. For example, EFAS 100 (FIG. 1) may report on a business's average carbon emissions for each dollar spent by the business. Financial statistics are well understood by business executives, who are often the final interpreters of a carbon footprint estimate.

During process 201, a combination of one-to-one, many-to-one, and one-to-many mappings between financial information and commodities (and services) may be created. For example, the mapping of financial line item 315 to service category 322, illustrated in FIG. 3, is a one-to-one mapping because a single financial line item is mapped to a single category.

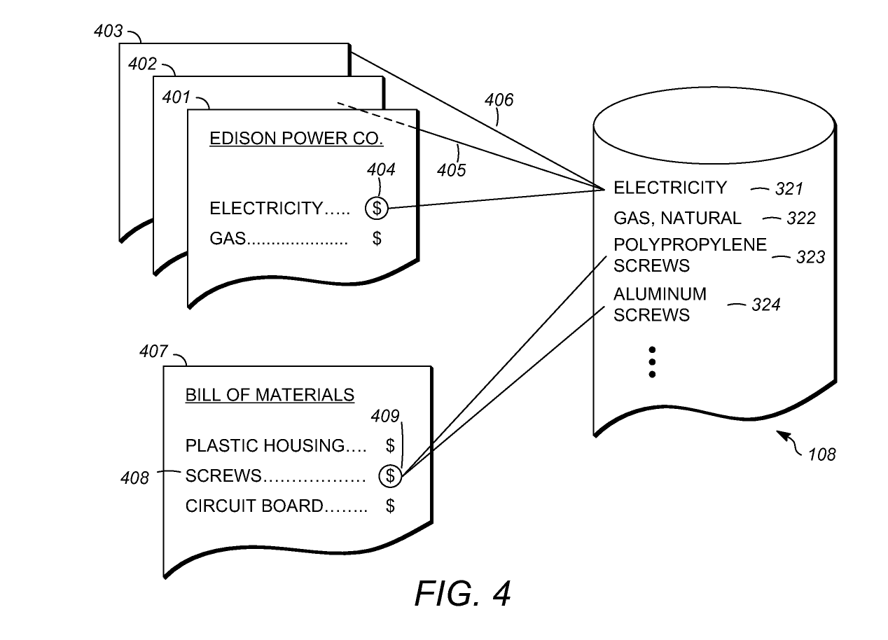

FIG. 4 depicts many-to-one and one-to-many mappings. Financial documents 401-403 are utility invoices charged to different factories of business entity 101, and contain financial line items 404-406 representing electricity usage at each factory. Financial line items 404-406 are mapped to electricity service category 321 (FIG. 3), thereby forming a many-to-one mapping relationship. Financial document 407 is a Bill of Materials, and contains financial line item 408 representing a purchase of screws. Although not directly indicated on Bill of Materials 407, the purchased screws may in fact include a combination of plastic screws and traditional metal screws. During process 201 (FIG. 2), the purchase of screws as indicated by financial line item 408 is mapped to commodity categories polypropylene screws 323 and aluminum screws 324 (FIG. 3). A percentage of dollar amount 409 spent on the combination of screws is assigned to categories 323 and 324 (FIG. 3). A one-to-many relationship is thus created between financial line item 408 and the various screws categories.

Optionally, supplementary information relating to a financial line item is collected during process 201 (FIG. 2). The recording of supplementary information can provide useful context during the reporting of a carbon footprint estimate by EFAS 100 (FIG. 1). For example, referring again to FIG. 4, as financial line items 404-406 are mapped to electricity service category 321, supplementary information such as the service provider's name and the factory in which each usage arose can be recorded. EFAS 100 (FIG. 1) utilizes the supplementary information relating to each financial line item to later report carbon footprint estimates due to each transaction (i.e., financial line item) on a financial document. For example, the supplier and factory information recorded from financial line items 404-406 allows EFAS 100 (FIG. 1) to later report on each supplier's and each factory's contribution to the carbon footprint of business entity 101 (FIG. 1).

Furthermore, in one embodiment, EFAS 100 (FIG. 1) uses the optional supplementary information to differentiate between the individual carbon footprint potentials of financial line items that have been mapped into a many-to-one relationship. For example, as discussed above, EFAS 100 allows multiple electricity usages to be mapped to a single category of electricity service. However, factors such as local electricity generation can affect the carbon footprint potential of one or more of the individual electricity usages within in the many-to-one relationship. In some states, electricity generation is cleaner due to the use of hydro-electric generators. In other states, electricity is less clean due to the use of coal-fired power plants. The optional supplementary information allows EFAS 100 (FIG. 1) to account for differences such as these in its carbon footprint assessments.

It should be recognized that the categories of supplementary information may vary. In one embodiment, the categories of supplementary information are provided by EFAS 100 (FIG. 1). In another embodiment, a user specifies the categories of supplementary information that may be recorded during the mapping process. In one embodiment, supplementary information recorded during process 201 (FIG. 2) involve the organization of a business entity. Organizational information may include information regarding the operations, supply chains, product lines of a business, and the like. For example, operations information may include, but is not limited to, business unit, departments, and locations information. Supply chain information may include, but is not limited to, supplier names and purchase dates. Product line information may include, but is not limited to, product name and product line information.

### 2. Environmental Database

The categories of commodities and services that may be mapped to financial information during process 201 are determined by the contents of environmental impacts database 108 (FIG. 1). In general, an environmental impacts database comprises related database modules that each contain environmental impact information. The related database modules may include a database module representing a matrix of input-output exchanges, a database module representing a matrix of environmental interventions, and a database module of conversion factors for different environmental interventions These modules are discussed, in turn, below.

An input-output exchanges module includes information on the inter-industry exchanges of commodities and services throughout the supply chains of various commodities and services in the United States. That is, the input-output module provides industry-wide averages for the consumption of commodities and services, due to the production of a particular commodity (or service). For example, the production of electricity requires the consumption of, among other things, coal, oil, and water. An input-output module includes information regarding the amounts of coal, oil, and water that are consumed on average by the electricity industry in its production of electricity.

An environmental intervention module includes data on the direct exchanges of materials and energy with the environment, due to the production of each commodity (or service) included in the input-output exchanges module. For example, the consumption of coal may release GHG to the atmosphere. An environmental intervention module includes amounts of different GHGs that are released due to the burning of coal.

A conversion module contains conversion factors used to express disparate environmental interventions in terms of a common unit of measurement (UOM). For example, the burning of coal may release carbon dioxide and nitrogen oxides into the atmosphere. A conversion module includes conversion factors that allow the global warming potential of nitrogen oxides to be expressed in kg-CO₂ equivalents per kg-NOx. Once expressed in terms of kg-CO₂ equivalents, the global warming potential of nitrogen oxides released by the burning of coal may be compared directly with that of the carbon dioxide also released by the burning.

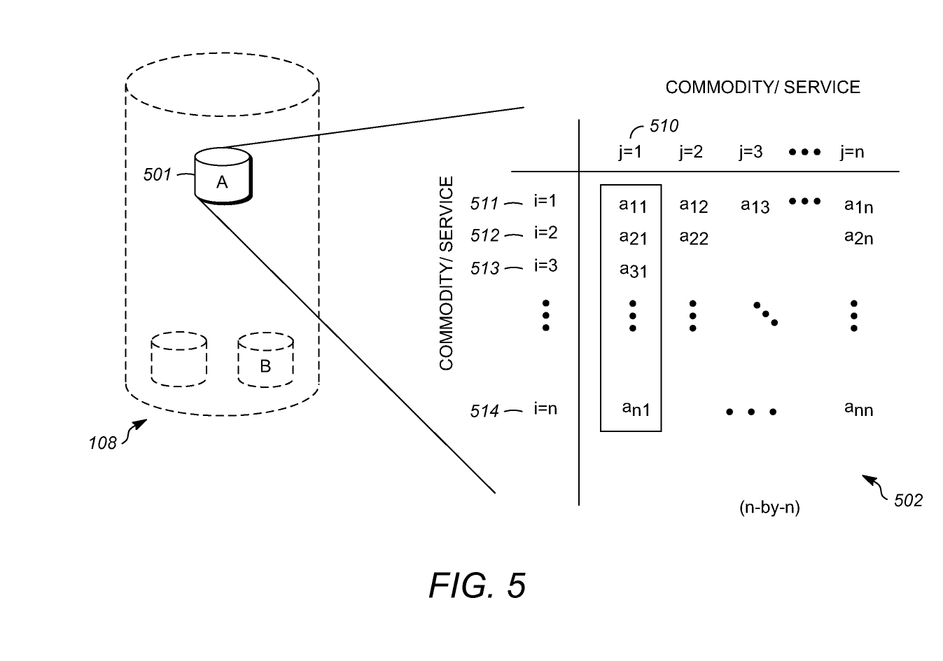

FIG. 5 illustrates an exemplary input-output module 501 used in the present embodiment. Input-output module 501 contains an n-by-n matrix 502 (matrix “A”), where n is the total number of commodities and services represented by input-output module 501. Let indices i and j stand for the numbering of rows and columns in matrix A 502, respectively. Each row of matrix A 502 represents a commodity (or service) that is produced, while each column of matrix A 502 represents a commodity (or service) that is consumed. Each matrix element at the intersection of a column and a row thus represents the consumption of a commodity (or service) during the production of another commodity (or service).

More specifically, matrix A 502 contains the inter-industry exchanges between commodities (and services) i and j where i,j=1 . . . n, and each matrix element aᵢⱼ represents the consumption of commodity-i (or service-i) during the production of commodity-j (or service j). For example, the production of commodity 510 requires the consumption of a₁₁ units of commodity 511, a21 units of commodity 512, a₃₁ units of 513 . . . and aₙ₁ units of commodity 514.

In the present embodiment, matrix A 502 is populated with values based on the Comprehensive Environmental Data Archive (“CEDA”) database. Element aᵢⱼ represents the fractional output of the entire industry that produces commodity-i (or service-i) that is consumed by the entire commodity-j (or service-j) industry in order to produce commodity-j (or service j). Exchange values for a total of 430 commodities and services are derived from the CEDA database and populated into matrix A 502. In another embodiment, matrix A 502 is populated with values based on industry-wide input-output exchanges maintained by the Carnegie Mellon University.

In another embodiment, element aᵢⱼ represents the fractional output of the entire commodity-i (or service-i) industry that is consumed by a subset of the commodity-j (or service j) industry, in order to fulfill the subset's production of commodity-j (or service j). For example, element aᵢⱼ may stand for the consumption of electricity by a specific manufacturer's factory. In yet another embodiment, matrix A 502 is based on a combination of supplier-specific input-output exchanges and industry-wide input-output exchanges based on a customized database and the CEDA database, respectively. One skilled in the art will appreciate that matrix A 502 may be populated based on other environmental databases as they are developed or as they evolve.

Table 1 illustrates an exemplary implementation of matrix A 502 as a 430-by-430 matrix containing the inter-industry exchanges of 430 categories of commodities and services. For example, Table 1 indicates that the production of fuel oil for storage requires the consumption of fuel oil from a refinery, and small amounts of steel, and electricity.

TABLE 1

| | Fuel oil, at | Fuel oil, at | Fuel oil, at | Steel, at | | Electricity |
|---|---|---|---|---|---|---|
| | boiler (1) | storage | refinery | plant | . . . | (430) |
| Fuel oil, at boiler (1) | 0 | 0 | 0 | 0 | . . . | 0.0018 |
| Fuel oil, at storage (2) | 1 | 0 | 0 | 0 | . . . | 0 |
| Fuel oil, at refinery (3) | 0 | 1 | 0 | 0 | . . . | 0 |
| Steel, at plant (4) | 6.12E−04 | 3.61E−10 | 4.73E−03 | 0 | . . . | 3.28E−08 |
| . | . | . | . | . | | . |
| . | . | . | . | . | | . |
| . | . | . | . | . | | . |
| Electricity (430) | 3.3E−05 | 1.21E−08 | 1.9E−06 | 8.3E−06 | . . . | 0 |

Furthermore, in some embodiments, matrix A 502 includes input-output exchange information related to the use and obsolescence of a commodity or service. The inclusion of environmental impacts due to the use and obsolescence of a product is necessary to determine an entity's downstream scope 3 emissions. The production of fuel oil for storage may be expressed in matrix A 502 as producing carbon dioxide, in addition to the consumption of fuel oil, steel, and electricity discussed above with respect to Table 1. The amount of carbon oxides expected to be produced by the eventual use of a quantity of fuel oil can be anticipated, and quantified in matrix A 502 as an input-output exchange value. Specifically, the value of element aᵢⱼ of matrix A 502 is used to indicate the production of carbon oxide, where “i” is the row of matrix A 502 representing carbon dioxide, and “j” is the column of matrix A 502 representing fuel oil for storage. The inclusion of use and obsolescence information in matrix A 502 allows EFAS 100 (FIG. 1) to assess downstream scope 3 emissions, in addition to scope 1, scope 2, and upstream scope 3 emissions.

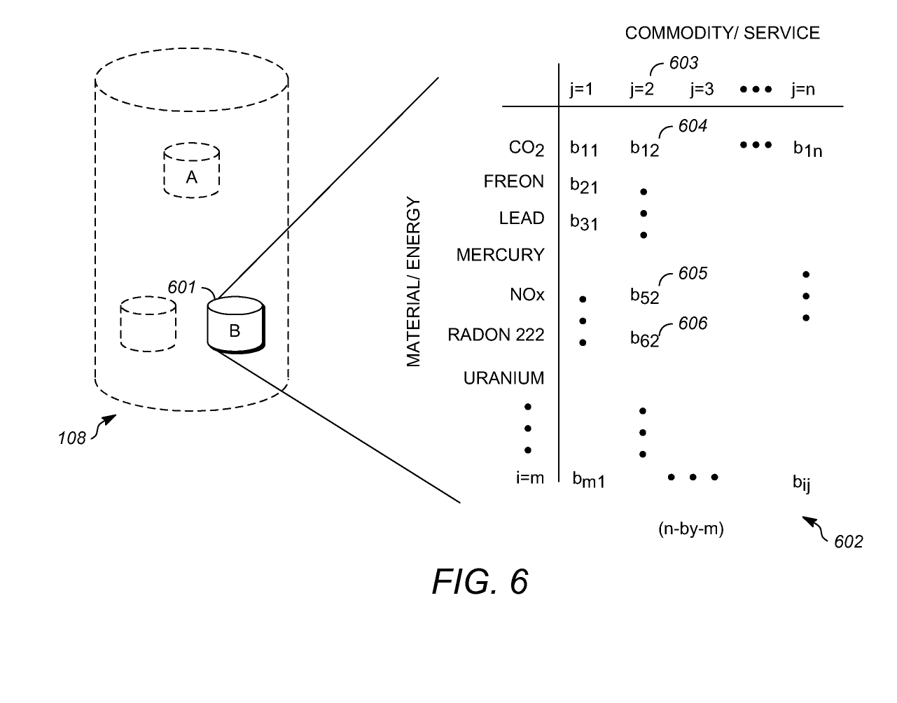

FIG. 6 illustrates an exemplary environmental intervention module 601 used in the present embodiment. Environmental intervention module 601 contains an n-by-m matrix 602 (hereafter matrix “B”) containing emission and consumption values bᵢⱼ.

Still referring to FIG. 6, let indices i and j stand for the numbering of rows and columns within matrix B 602, respectively. Each matrix column represents a commodity (or service) that is produced, and each matrix row represents the emission or consumption of a material or energy. Each element bᵢⱼ of matrix B 602 thus represents the emission or resource consumption of material-j (or energy j) due to the production of commodity-i (or service-i), where i=1 . . . m and k=1 . . . n. For example, the production of commodity-i 603 involves the emission of b₁₂ amounts of carbon dioxide (element 604), b₅₂ amounts of nitrogen oxide (element 605), and b₆₂ amounts of radon-222 (element 606). Matrix elements 604, 605, and 606 are referred to as environmental interventions.

In the present embodiment, matrix B 602 is populated with values based on the CEDA database. Matrix B 602 includes approximately 2,500 environmental interventions related to the 430 commodities and services included in input-output module 501 (FIG. 5). That is, n=430 and m=2,500, approximately. In another embodiment, matrix B 602 is populated with values based on an environmental database maintained by the Carnegie Mellon University. In yet another embodiment, matrix B 602 is populated with a combination of values based on existing environmental databases and customized values, which may be based on, for example, supplier-specific environmental invention data. One skilled in the art will appreciate that matrix B 602 may be populated based on other environmental databases as knowledge of environmental interventions becomes further developed or evolved.

Table 2 illustrates an exemplary implementation of matrix B 602 (FIG. 6) as a 430-by-2,500 matrix containing 2,500 environmental interventions (i.e., emission and consumption) for each of the 80 commodities listed in matrix A 502 (FIG. 5).

TABLE 2

| | Fuel oil, at | Fuel oil, at | Fuel oil, at | Steel, at | | |
|---|---|---|---|---|---|---|
| | boiler | storage | refinery | plant | . . . | Electricity |
| Carbon dioxide [kg] | 0.085 | 0.0271 | 0.308 | 1.58 | . . . | 0.45 |
| Sulfur oxide [kg] | 8E−05 | 2.3E−05 | 0.0025 | 0.002 | . . . | 0.00216 |
| Nitrogen oxides [kg] | 2.9E−05 | 3.9E−04 | 5.3E−04 | 0.0016 | . . . | 8.46E−05 |
| . | . | . | . | . | | . |
| . | . | . | . | . | | . |
| . | . | . | . | . | | . |
| Radon-222 [kBq] | 0 | 0 | 0 | 0 | . . . | 0.512 |

A third module of environmental impacts database 108 used in the present embodiment is a characterization factor module. The characterization factor module includes factors for converting different environmental interventions into a common unit of measurement (UOM). In the present embodiment, the characterization factor module is based on the CEDA database. The characterization factor module is adapted to convert different global warming potentials into a common UOM called CO₂-equivalents, meaning that the global warming potentials for any of the environmental interventions contained in module 601 (FIG. 6) may be expressed in terms of CO₂-equivalents. Once expressed in a common UOM, each environmental intervention may be compared with one another. The environmental interventions may also be aggregated into a total carbon footprint value.

In another embodiment, the characterization factor module includes values for converting global warming potentials into other UOMs. For example, global warming potentials may be reported in terms of other GHGs, such as water vapor, methane, nitrous oxide, zone, and so forth. The characterization factor module may include factors for converting global warming potentials in terms of other GHGs, including but not limited to those listed here.

It should also be noted that, although the examples above are provided in the context of database modules of specific sizes (e.g., input-output module 501 in FIG. 5 was illustrated as a 430-by-430 matrix), EFAS 100 (FIG. 1) may be adapted to utilize environmental impact database modules of various sizes, as long as the relationship between the database modules, as discuss above, remain intact.

### 3. Environmental Footprint Estimate

Referring back to FIG. 1 and FIG. 2, in process 202 (FIG. 2), carbon footprint 109 for business entity 101 is determined based on the mapping of financial information 102 performed in process 201 (FIG. 2) and environmental impacts database 108.

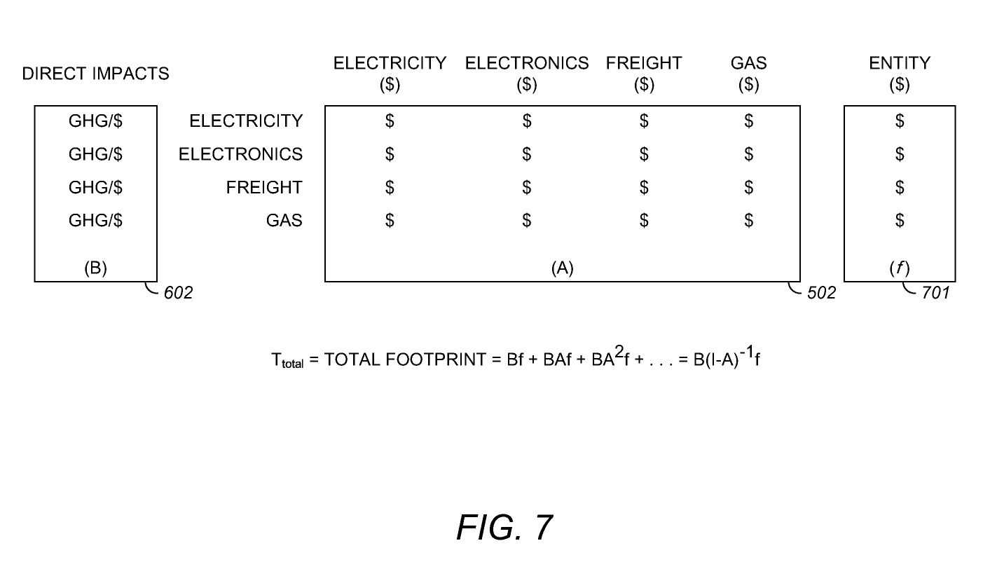

FIG. 7 illustrates an exemplary equation for determining a carbon footprint in matrix notation. Matrix A 502 (FIG. 5) represents input-output module 501 of environmental impacts database 108. Matrix B 602 (FIG. 6) represents environmental intervention module 601 (FIG. 6) of environmental impacts database 108 (FIG. 1). Matrix f 701 represents the mapping of financial information to commodities and services performed in process 201 (FIG. 2).

A carbon footprint can be expressed in terms of matrices A (502), B (602), and f (701) as shown in FIG. 7. Let T₀ stand for the carbon footprint caused by the direct consumption of materials and energy by business entity 101 (FIG A). In matrix notation:

T₀=Bf (EQ. 1)

Let T₁ Stand for the Carbon Footprint of the Direct Suppliers of Business Entity 101 (FIG. 1). In matrix notation:

T₁=BAf (EQ. 2)

Let T₂ stand for the carbon footprint of suppliers who are once-removed from business entity 101 (FIG. 1). In other words, T₂ represents the carbon footprint of the suppliers of its direct suppliers. In matrix notation:

T₂=BA²f (EQ. 3)

Thus, the Total Carbon Footprint Caused by Business Entity 101 (FIG. 1) Directly and indirectly (i.e., by its upstream suppliers) is expressed in matrix notation as:

$${T}_{total} = {Lim}_{n \to ∞} ( Bf + BAf + {BA}^{2} f + … + {BA}^{n} f ) \qquad ( EQ . 4 )$$

The infinite series of EQ. 4 can be reduced to:

Tₜₒₜₐₗ=B(I−A)⁻¹f, (EQ. 5)

where I is an identity matrix of the same size as matrix A.

Tₜₒₜₐₗ represents carbon footprint estimate 109 for business entity 101 (FIG. 1) in terms of the materials and energy contained within environmental intervention module 601 (FIG. 6). For example, carbon footprint estimate Tₜₒₜₐₗ may indicate the emission of gaseous oxides in kilograms and radioactive wastes in kilo-Becquerel due to electricity use by business entity 101 (FIG. 1).

### 4. Viewing Carbon Footprint Estimates

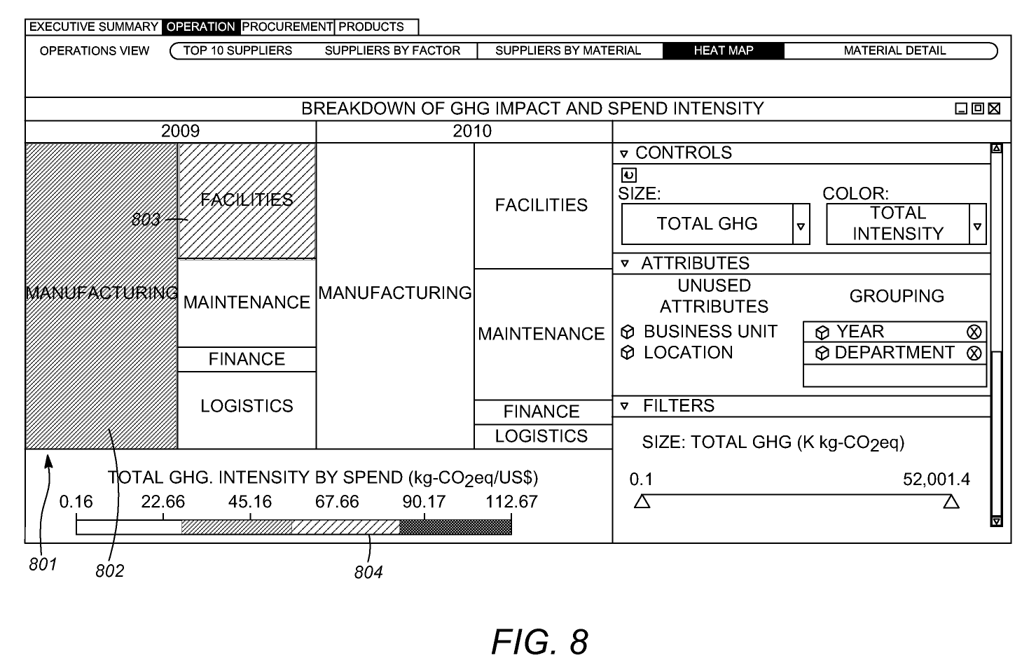

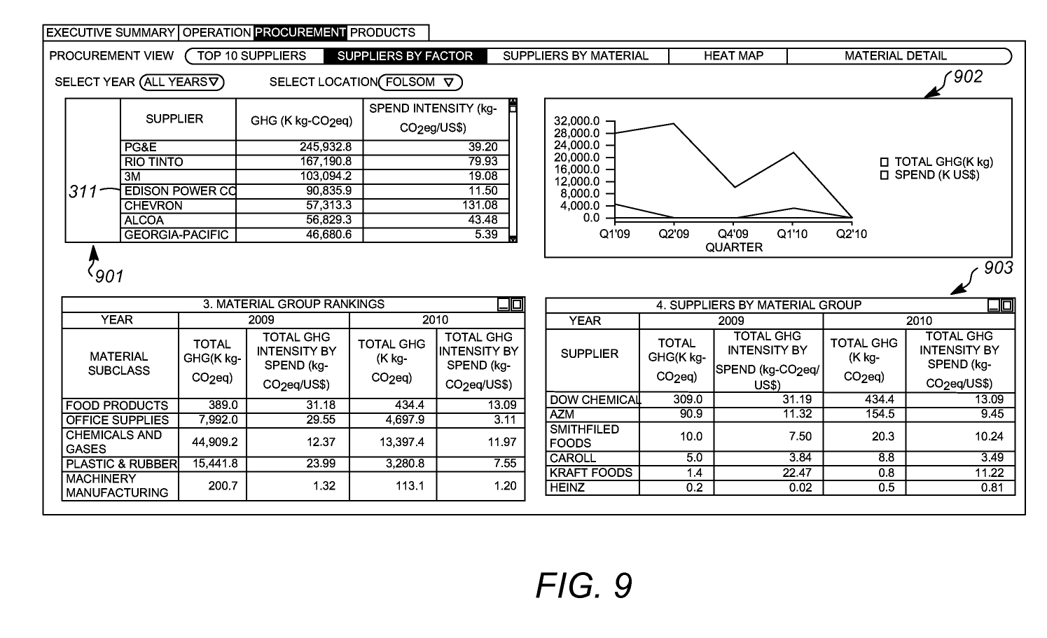

Referring back to FIG. 2, in display process 203, a user reviews carbon footprint estimate 109 (i.e., Tₜₒₜₐₗ). Furthermore, in process 204, the user identifies areas of spending that are significant in carbon emissions. FIGS. 8-9 depict an exemplary web user interface that can be used by the user to review carbon footprint estimate 109 and to identify significant carbon footprint contributors.

The screen depicted in FIG. 8, called a heat map 801, presents GHG emissions and GHG intensities attributable to units within business entity 101 (FIG. 1). GHG intensity represents the ratio of GHG emissions per dollar spent, and is expressed in terms of kg-CO₂-equivalent/USD in the present example. Each rectangle within heat map 801 is associated with a unit of business entity 101 (FIG. 1). Rectangles 802 and 803 are color coded.

As shown in exemplary heat map 801, rectangle 802 represents the manufacturing department of business entity 101 (FIG. 1), and rectangle 803 represents the facilities department of business entity 101 (FIG. 1). The sizes of rectangles 802 and 803 correspond to each department's GHG emissions. The colors of rectangles 802 and 803 correspond to each department's GHG intensity. Rectangle 802 is larger than rectangle 803, which indicates that the manufacturing department emits more GHGs than the facilities department. However, rectangle 802 is green while rectangle 803 is red, which indicates that the facilities department emits more GHGs per dollar spent (i.e., higher GHG intensity) than the manufacturing department.

The screen depicted in FIG. 9 presents the GHG emissions and GHG intensities that are attributable to suppliers of business entity 101 (FIG. 1). Each row in table 901 is related to a supplier, and contains information about the GHG emission and GHG intensity of the supplier. The rows within table 901 can be selected by a user. When a row (i.e., a supplier) is selected, graph 902 and table 903 are updated to display carbon footprint information for the selected supplier. As shown in the exemplary report of FIG. 9, graph 902 is used to display spending and GHG emission trends for the selected supplier. Table 903 is used to display the types of commodities and services supplied by the selected supplier, and the selected supplier's contribution to the carbon footprint of those commodities and services. Here, tables 901 and 903 point to supplier 311 (FIG. 3) as a significant carbon footprint contributor.

Other web user interface reports may be provided by EFAS 100. For instance, in one embodiment, a web user interface illustrates the profit of a product line as compared with the environmental impacts due to the production of the product line. In another embodiment, a web user interface illustrates supplier materials or product revenue mapped against environmental impacts. In yet another embodiment, a web user interface illustrates the environmental impacts attributable to sub-organizations within an entity as a department, or a product division responsible for the design and marketing of a particular product.

### 5. Expansion

The environmental database used by EFAS 100 (FIG. 1) may be expanded to include environmental impact potentials that are specific to an entity and its supply chain. An expanded environmental impacts database enables EFAS 100 (FIG. 1) to produce carbon footprint assessments that account for environmental impact potentials that are specific to the entity and its supply chain.

Referring again to FIG. 2, in decision 205, a decision is made as to whether to perform another iteration of the present process with additional focus on the areas of spending that were identified during process 204. The example below is provided in the context of a user having identified supplier 311 (FIG. 3) for further analysis using the screen depicted in FIG. 9, during process 204. As discussed above, supplier 311 (FIG. 3) provides electricity and gas services to business entity 101 (FIG. 1).

Still referring to FIG. 2, in process 206, an expanded environmental impacts database 208 is created to include environmental impact information that is specific to supplier 311 (FIG. 3) and its supply chain for electricity and gas. The expanded environmental impacts database 208 is used in a subsequent iteration of the present process to obtain a carbon footprint estimate that reflects the impact of supplier 311 (FIG. 3) and its supply chain in additional detail.

In process 206 of the present embodiment, input-output module 501 (FIG. 5) of environmental impacts database 108 is expanded to include information related to input-output exchanges due to the production of electricity and gas by supplier 311 (FIG. 3). The expanded input-output module becomes a component of expanded environmental impacts database 208.

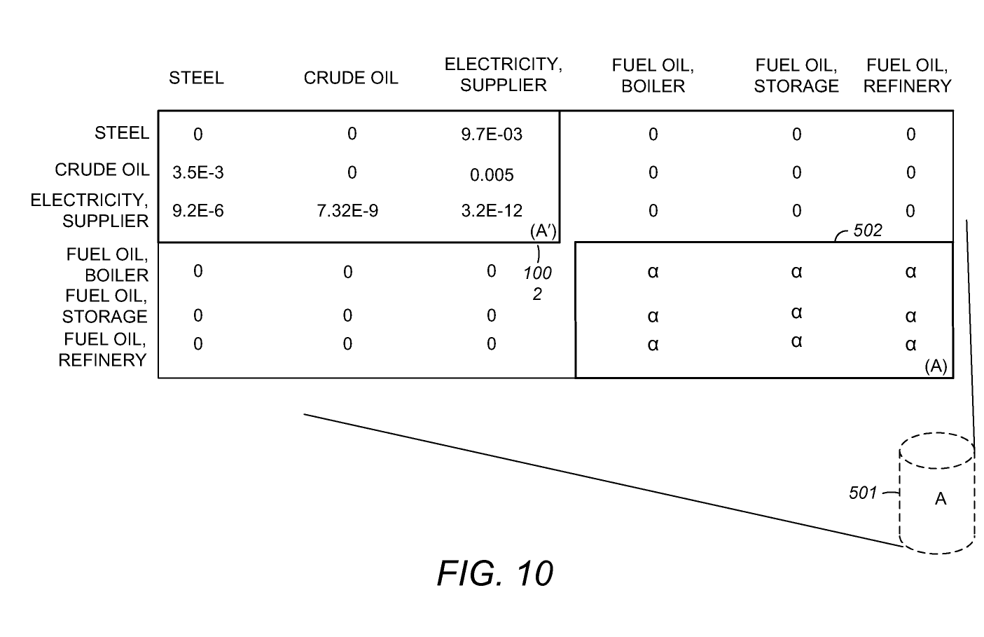

FIG. 10 illustrates, in matrix form, the expansion of input-output module 501 (FIG. 5). To begin with, information regarding the exchange of commodities and services specific to supplier 311 (FIG. 3) and its supply chain are structured into the format of a p-by-p matrix A′ (1002). Like matrix A 502, each row of matrix A′ 1002 represents a commodity (or service) that is produced by supplier 311 (FIG. 3) and its supply chain, and each column of matrix A′ 1002 represents a commodity (or service) that is consumed by supplier 311 and its supply chain. Each element αᵢⱼ of matrix A′ 1002 thus indicates the consumption of commodity-j (or service j) due to the production of commodity-i (or service-i) by supplier 311. Elements αᵢⱼ are also known as input-output exchanges.

Table 3 illustrates an exemplary implementation of matrix A′ 1002 as a 3-by-3 matrix. For example, the production of electricity by supplier 311 (FIG. 3) is shown as requiring the consumption of crude oil, steel, and a minimal amount of electricity (due to, for example, overhead).

TABLE 3

| | | | Electricity, at |
|---|---|---|---|
| | Steel | Crude oil | supplier 311 |
| Steel | 0 | 0 | 9.7E−03 |
| Crude oil | 3.5E−03 | 0 | 0.005 |
| Electricity, at supplier 311 | 9.2E−06 | 7.32E−09 | 3.2E−12 |

Once matrix A′ 1002 is properly structured, matrix A 502 is expanded so that the elements of matrix A′ 1002 may be included into expanded matrix A 502. Matrix A 502, originally a n-by-n matrix, is expanded into a (n+p)-by-(n+p) matrix so that it can accommodate the elements of matrix A′ 1002, a p-by-p matrix. The existing elements of matrix A 502 (i.e., aᵢⱼ where i,j=1 . . . n) are retained in the portion of expanded matrix A 502 defined by aᵢⱼ where i,j=(p+1) . . . (n+p). Elements from matrix A′ 1002 (i.e., input-output exchanges for supplier 311) occupy the portion of expanded matrix A 502 defined by aᵢⱼ where i,j=1 . . . p.

Referring again to FIG. 2, in process 206 of the present embodiment, environmental interventions module 601 (FIG. 6) is also expanded to include environmental interventions for the commodities and services produced by supplier 311 (FIG. 3) and its supply chain. The expanded environmental interventions module also becomes a component of expanded environmental impacts database 208.

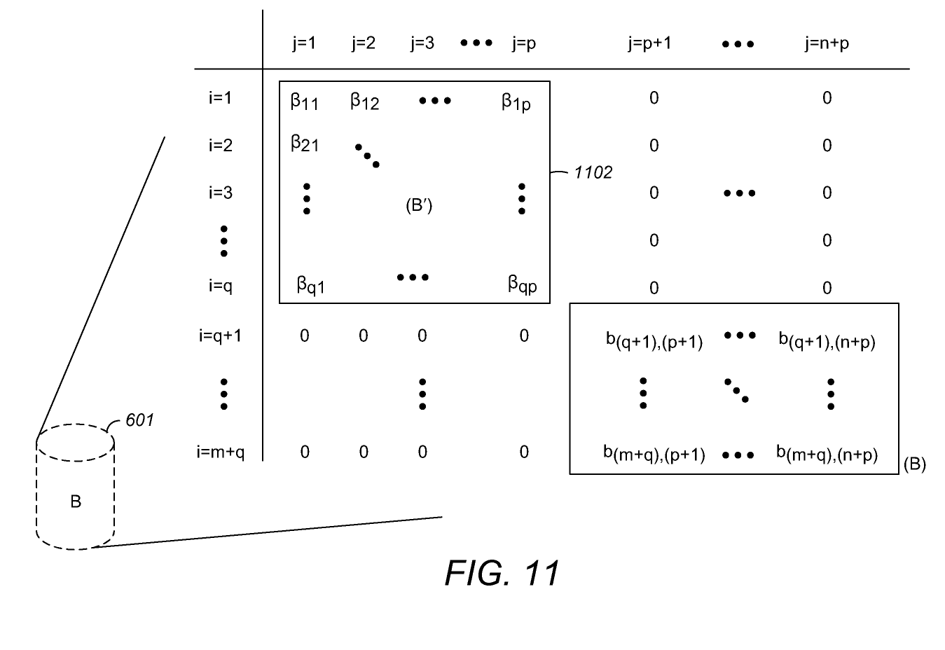

FIG. 11 illustrates, in matrix form, the expansion of environmental interventions module 601. Recall that matrix B 602 represents the structure and contents of environmental interventions module 601 (FIG. 6). Similar to the expansion of input-output module 501 (FIG. 5) discussed above, information regarding environmental interventions that are specific to supplier 311 (FIG. 3) and its supply chain are structured into the format of a p-by-q matrix B′ (1102). Like matrix B 602, each column of matrix B′ 1102 represents a commodity (or service) that is consumed by supplier 311 and its supply chain, and each row of matrix B′ 1102 represents the emission or consumption of a material or energy. Each element βᵢⱼ in matrix B′ 1102 thus indicates the emission or consumption of material-i (or energy-i) due to the consumption of commodity-j (or service j) by supplier 311 (FIG. 3) and its supply chain.

Table 4 illustrates an exemplary implementation of matrix B′ 1102.

TABLE 4

| | | Electricity, at | | Gas, at |
|---|---|---|---|---|
| | Fuel oil, at | supplier 311 | Gas, at plant | supplier |
| | plant A (1) | (2) | A (3) | 311 (4) |
| Uranium [kg] | 0 | 1.44E−06 | 0 | 0 |
| Vanadium [kg] | 0 | 2.34E−11 | 0 | 8.92E−09 |

Once matrix B′ 1102 is properly structured, matrix B 602 is expanded so that the elements of matrix B′ 1102 may be included into expanded matrix B 602. Specifically, matrix B 602, originally a n-by-m matrix, is expanded into a (n+p)-by-(m+q) matrix so that it can accommodate the elements of matrix B′ 1102, a p-by-q matrix. The existing elements of matrix B 602 (i.e., bᵢⱼ where i=1 . . . m and j=1 . . . n) are retained in the portion of expanded matrix B 602 defined by bᵢⱼ where i=(q+1) . . . (m+q) and j=(p+1) . . . (n+p). New elements from matrix B′ 1102 (i.e., the additional environmental interventions) occupy the portion of expanded matrix B 602 defined by bᵢⱼ where i=1 . . . m and j=1 . . . n.

### 6. Hybridization

Moreover, the expansion of input-output module 501 (FIG. 5) allows for a hybridization of supplier-specific input-output exchanges with industrial-average input-output exchanges. As used here, hybridization refers to the inclusion of supplier-specific environmental exchanges into input-output module 501 (FIG. 5). Recall that input-output module 501 (FIG. 5) can be expanded to include supplier-specific values and industry-wide averages for input-output exchanges. Hybridization occurs when a supplier's production of a commodity (or service) involves an exchange with a commodity (or service) that is specific to the supplier, and also an exchange with a commodity (or service) that is based on the industry-wide average for the commodity (or service).

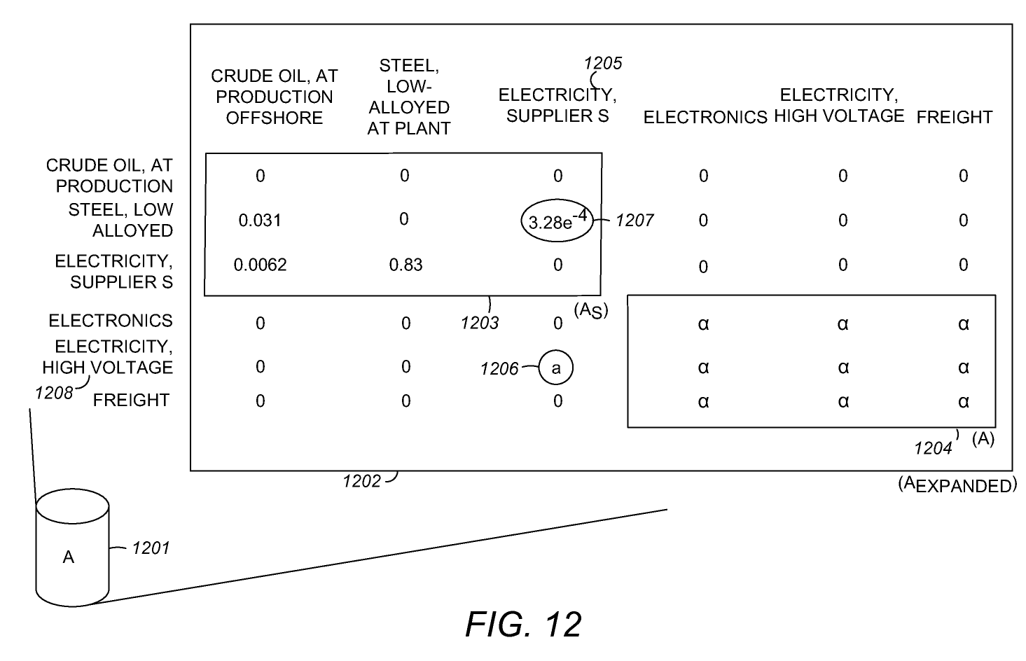

FIG. 12 graphically illustrates the hybridization of input-output exchanges. Matrix A_{expanded} 1202 illustrates, in matrix form, an input-output module 501 (FIG. 5) which has been expanded in accordance with the expansion technique discussed above. Specifically, matrix A_{expanded} 1202 includes industry-wide exchanges contained in matrix A 1204 and exchanges contained in matrix A_{S} 1203, which are specific to supplier S.

Commodity 1205 includes a hybridized exchange 1206 because production of commodity 1205 (by supplier S) consumes, first, commodities 1207 that are specific to supplier S, and second, an amount of electricity that is based on industry-wide averages as represented by element 1206. Such an input-output exchange scenario occurs when a supplier produces only a fraction of what it sells, and fulfills the remaining fraction by purchasing the commodity from other suppliers. That is, in FIG. 12, supplier S produces only a fraction of the electricity that it sells, and purchases the remaining fraction of electricity from other power companies for resell. Input-output exchanges 1207 reflect the production of electricity by Supplier S, and input-output exchange 1206 accounts for the electricity that it purchases.

### 6. Iteration

Referring back to FIG. 2, once the creation of expanded environmental impacts database 208 in process 206 is complete, the carbon footprint assessment process of the present embodiment begins its next iteration at process 201. In process 201, a re-mapping of certain portions of financial information 102 (FIG. 1) is necessary. Since the input-output module of expanded environmental impacts database 208 (FIG. 2) includes supplier-specific exchange information, financial line items that relate to the expanded supplier-specific exchange information should be re-mapped accordingly.

For example, if input-output module 501 (FIG. 5) is updated to include exchange information that are specific to supplier S, then any financial line items from supplier S's invoices should not remain mapped to the industry-wide average exchanges in input-output module 501 (FIG. 5), and should be re-mapped to the exchanges in input-output module 501 (FIG. 5) that are specific to supplier S instead.

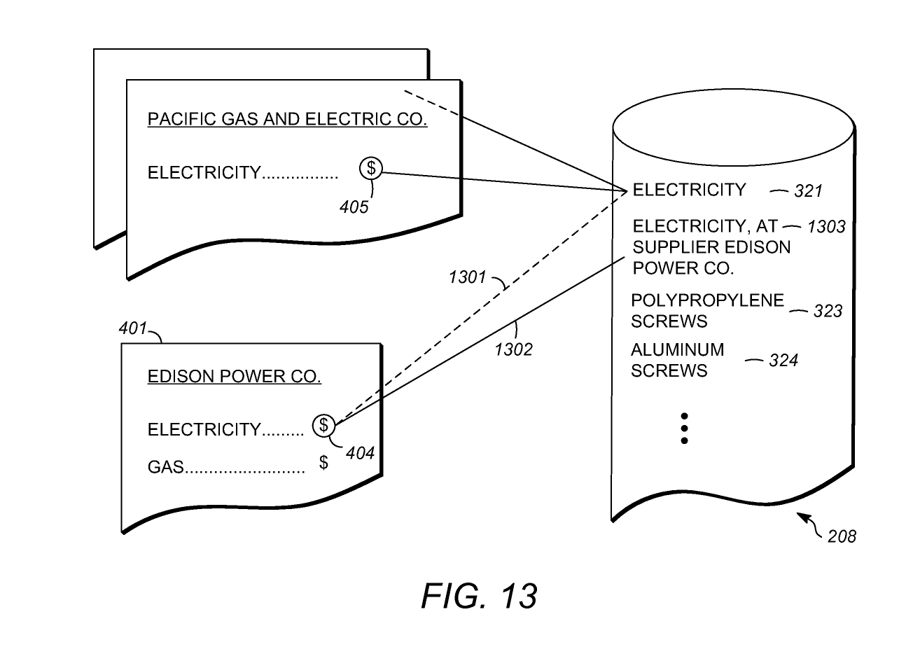

FIG. 13 illustrates the re-mapping of financial line item 404 (FIG. 4) from supplier S's invoice 401 (FIG. 4). Dotted line 1301 represents the earlier mapping of financial line item 404 (FIG. 4) to commodity 321 (FIG. 3) of expanded environmental impacts database 208 (FIG. 2), which reflects the industry-wide average input-output exchanges for electricity. Since financial line item 404 (FIG. 4) indicates a purchase of electricity from supplier S, it should be re-mapped to commodity 1303, which is available in expanded input-output module 501 and represents the input-output exchanges specific to supplier S's production electricity. The new mapping is illustrated by line 1302.

Referring back to FIG. 2, upon the completion of re-mapping in process 201, the present process proceeds to process 202. In process 202, EQ. 6 is executed again based on the expanded environmental impacts database 208 (FIG. 1) and expanded mapping information u_{pdated} to produce updated carbon footprint estimate 109 (FIG. 1).

Iᵢₜₑᵣₐₜᵢₒₙ=B_{updated}(I−A_{updated})⁻¹f_{updated}, (EQ. 6)

where A_{updated} is an expanded input-output module, B_{updated} is an expanded environmental intervention module, and I is an identity matrix of the same size as matrix A_{updated},

The embodiments described herein are typically implemented in the form of computer software (computer-executable instructions) executed on a computer system. The computer system may include, for example, a processor, memory, storage, and peripheral devices (e.g., monitor, keyboard, disk drive, network interface, etc.).

Additionally, a computer-readable medium can be used to store (e.g., tangibly embody) one or more computer programs for performing any one of the above-described processes by means of a computer. The computer program may be written, for example, in a general-purpose programming language (e.g., C, C++, Java) or some specialized, application-specific language.

Although only certain exemplary embodiments of this invention have been described in detail, those skilled in the art will readily appreciate that many modifications are possible in the exemplary embodiments without materially departing from the novel aspects of the described embodiments. For example, aspects of embodiments disclosed above can be combined in other combinations to form additional embodiments. Accordingly, all such modifications are intended to be included within the scope of this invention.

What is claimed is:

1. A computer-implemented method for assessing and displaying an environmental footprint of an entity by analyzing financial data regarding the entity, implemented by a computer, wherein the computer comprises a processor, the method comprising:
accessing the financial data of the entity, wherein the financial data represents the entity's spending on a plurality of financial items;
accessing a first environmental impact database, wherein the first environmental impact database includes a matrix of appropriations between each spend item of a plurality of spend items, and the other spend items of the plurality of spend items, wherein each appropriation represents a consumption or an emission of one or more of the plurality of spend items, due to producing or consuming of a spend item of the plurality of spend items;
receiving a determination of one or more relationships between one or more of the financial items of the financial data, and one or more of the spend items of the first environmental impact database;
accessing a second environmental impact database, wherein the second environmental impact database includes a plurality of environmental impacts, wherein each of the plurality of spend items is correlated to one or more of the plurality of environmental impacts, and wherein each of the plurality of environmental impacts represents an emission or a removal of a resource of a plurality of resources;
calculating a first environmental footprint estimate, based on the one or more relationships, the first environmental impact database, and the second environmental impact database; wherein the first environmental footprint estimate includes the emission or the removal of the plurality of resources related to the plurality of financial items of the entity;
adding a new spend item to the first environmental database;
updating, in the first environmental database, the appropriation between the new spend item, and the other spend items of the plurality of spend items;
calculating a second environmental footprint estimate corresponding to the plurality of financial items of the financial data, based on the one or more relationships, the updated first environmental impact database, and the second environmental impact database, wherein the second environmental footprint estimate includes the emission or the removal of the plurality of resources related to the plurality of financial items of the entity; and
causing a display of the second environmental footprint estimate in relation to the financial items of the entity.

2. The method of claim 1, further comprising:
receiving an identification of a target spend item from the plurality of spend items of the first environmental impact database based on the first environmental impact estimates;
updating, in the first environmental impact database, the appropriation between the target spend item, and the other spend items of the plurality of spend items; and
calculating a third environmental footprint estimate corresponding to the plurality of financial items of the financial data, based on the relationship, the updated first environmental impact database, and the second environmental impact database.

3. The method of claim 1, further comprising:
adding, to the second environmental database, an environmental impact that is correlated to the new spend item; and
calculating a third environmental footprint estimate corresponding to the plurality of financial items of the financial data, based on the relationship, the updated first environmental impact database, and the updated second environmental impact database.

4. The method of claim 1, wherein:
the first environmental footprint estimate and the second environmental footprint estimate estimates the consumption or the emission of plurality of resources due to activities by one or more suppliers upstream from the entity.

5. The method of claim 1, wherein:
the first environmental footprint estimate and the second environmental footprint estimate estimates the consumption or the emission of plurality of resources due to activities by one or more consumers downstream from the entity.

6. The method of claim 1, wherein:
one or more of the plurality of resources is a greenhouse gas.

7. The method of claim 1, wherein:
one or more of the plurality of resources is an energy.

8. The method of claim 1, wherein:
the receiving of the determination of one or more relationships further includes the receiving of an organizational data, wherein the organizational data is related to the entity.

9. The method of claim 1, wherein:
the first environmental impact database and the second environmental impact database are based on the Comprehensive Environmental Data Archive database.

10. The method of claim 1, wherein:
the display of the second environmental footprint estimate accounts for every relationship of the one or more relationships between the plurality of financial items and the plurality of spend items.

11. An environmental footprint assessment system, comprising:
a first environmental impact database, wherein the first environmental impact database includes a matrix of appropriations between each spend item of a plurality of spend items, and the other spend items of the plurality of spend items, wherein each appropriation represents a consumption or an emission of one or more of the plurality of spend items, due to producing or consuming of a spend item of the plurality of spend items;
a second environmental impact database, wherein the second environmental impact database includes a plurality of environmental impacts, wherein each of the plurality of spend items is correlated to one or more of the plurality of environmental impacts, and wherein each of the plurality of environmental impacts represents an emission or a removal of a resource of a plurality of resources;
a server adapted to:
access a financial data of an entity, wherein the financial data represents the entity's spending on a plurality of financial items;
receive a determination of one or more relationships between one or more of the financial items of the financial data, and one or more of the spend items of the first environmental impact database;
calculate a first environmental footprint estimate, based on the one or more relationships, the first environmental impact database, and the second environmental impact database; wherein the first environmental footprint estimate includes the emission or the removal of the plurality of resources related to the plurality of financial items of the entity;
add a new spend item to the first environmental database;
update, in the first environmental database, the appropriation between the new spend item, and the other spend items of the plurality of spend items;
calculate a second environmental footprint estimate corresponding to the plurality of financial items of the financial data, based on the one or more relationships, the updated first environmental impact database, and the second environmental impact database, wherein the second environmental footprint estimate includes the emission or the removal of the plurality of resources related to the plurality of financial items of the entity; and
cause a display of the second environmental footprint estimate in relation to the financial items of the entity.

12. The system of claim 11, wherein the server is further adapted to:
receive an identification of a target spend item from the plurality of spend items of the first environmental impact database, based on the first environmental impact estimate;
update, in the first environmental impact database, the appropriation between the target spend item, and the other spend items of the plurality of spend items; and
calculate a third environmental footprint estimate corresponding to the plurality of financial items of the financial data, based on the relationship, the updated first environmental impact database, and the second environmental impact database.

13. The system of claim 11, wherein:
the first environmental footprint estimate and the second environmental footprint estimate estimates the consumption or the emission of plurality of resources due to activities by one or more consumers downstream from the entity.

14. The system of claim 11, wherein:
one or more of the plurality of resources is a greenhouse gas.

15. The system of claim 11, wherein:
the receiving of the determination of one or more relationships further includes the receiving of an organizational data, wherein the organizational data is related to the entity.

16. The system of claim 11, wherein:
the display of the second environmental footprint estimate is configured to account for every relationship of the one or more relationships between the plurality of financial items and the plurality of spend items.

17. A non-transitory computer-readable storage medium having computer-executable instructions for estimating and displaying a demand for an exchange-listed product, comprising instructions for:
accessing the financial data of the entity, wherein the financial data represents the entity's spending on a plurality of financial items;
accessing a first environmental impact database, wherein the first environmental impact database includes a matrix of appropriations between each spend item of a plurality of spend items, and the other spend items of the plurality of spend items, wherein each appropriation represents a consumption or an emission of one or more of the plurality of spend items, due to producing or consuming of a spend item of the plurality of spend items;
receiving a determination of one or more relationships between one or more of the financial items of the financial data, and one or more of the spend items of the first environmental impact database;
accessing a second environmental impact database, wherein the second environmental impact database includes a plurality of environmental impacts, wherein each of the plurality of spend items is correlated to one or more of the plurality of environmental impacts, and wherein each of the plurality of environmental impacts represents an emission or a removal of a resource of a plurality of resources;
calculating a first environmental footprint estimate, based on the one or more relationships, the first environmental impact database, and the second environmental impact database; wherein the first environmental footprint estimate includes the emission or the removal of the plurality of resources related to the plurality of financial items of the entity;
adding a new spend item to the first environmental database;
updating, in the first environmental database, the appropriation between the new spend item, and the other spend items of the plurality of spend items;
calculating a second environmental footprint estimate corresponding to the plurality of financial items of the financial data, based on the one or more relationships, the updated first environmental impact database, and the second environmental impact database, wherein the second environmental footprint estimate includes the emission or the removal of the plurality of resources related to the plurality of financial items of the entity; and
causing a display of the second environmental footprint estimate in relation to the financial items of the entity.

18. The computer-readable storage medium of claim 17, further comprising instructions for:
receiving an identification of a target spend item from the plurality of spend items of the first environmental impact database based on the first environmental impact estimates;
updating, in the first environmental impact database, the appropriation between the target spend item, and the other spend items of the plurality of spend items; and
calculating a third environmental footprint estimate corresponding to the plurality of financial items of the financial data, based on the relationship, the updated first environmental impact database, and the second environmental impact database.

19. The computer-readable storage medium of claim 17, wherein:
the first environmental footprint estimate and the second environmental footprint estimate estimates the consumption or the emission of plurality of resources due to activities by one or more consumers downstream from the entity.

20. The computer-readable storage medium of claim 17, wherein:
the receiving of the determination of one or more relationships further includes the receiving of an organizational data, wherein the organizational data is related to the entity.
